(19) United States
(12) Patent Application Publication
(10) Pub. No.: US 2016/0325674 A1
(43) Pub. Date: Nov. 10, 2016

(54) STACKED TRANSPARENT LIGHTING SYSTEM FOR VEHICLE TRIM COMPONENTS

(71) Applicant: MAGNA INTERNATIONAL INC., Aurora (CA)

(72) Inventors: Brian A. Krull, Sterling Heights, MI (US); Robert M. Horner, Plymouth, MI (US); Mark T. Pilette, Oxford, MI (US)

(73) Assignee: Magna International Inc., Aurora, ON (CA)

(21) Appl. No.: 15/108,871

(22) PCT Filed: Jan. 16, 2015
(86) PCT No.: PCT/US15/11799

§ 371 Date: Jun. 29, 2016

Related U.S. Application Data
(60) Provisional application No. 61/928,055, filed on Jan. 16, 2014.

(51) Int. Cl. B60Q 3/00; B60Q 3/04; B60Q 3/02

(52) U.S. Cl. CPC B60Q 3/004; B60Q 3/0209; B60Q 3/044; B60Q 2500/10

(57) ABSTRACT

A stacked transparent lighting arrangement for a vehicle interior trim component. The vehicle interior trim component can be any trim component or visible surface in the interior of a vehicle. Examples include but are no limited to an instrument panel, arm rest, glove compartment door, door trim piece, headliner, foot pedal or seat cover. The lighting arrangement includes a housing forming part of the vehicle interior trim component. On or more layers of transparent optics contained in the housing with a appearance formed each of the one or more layers of transparent optics. The appearance can be any type of numbers, letters, graphics or other indicia, including but not limited to words, logos or designs.

### FIELD OF THE INVENTION

The present invention is directed to an arrangement for illuminating vehicle components such as trim components using multiple appearance layers behind a translucent lens.

### BACKGROUND OF THE INVENTION

In current vehicle designs it is often desirable to back light the trim components of the interior of the vehicle in order to display designs, graphics or colors or some other desirable visual effect. Typically, designs placed on films are available that create a certain appearance when not back lit but create a perception or additional appearance after being back lit. The disadvantage of such designs is that the unlit appearance actually contains the lit appearance, but is muted, or incorporated into the design and not actually a different design (one in the same). There are also other available components that use colored filters and opposite color projection on the spectrum of appearance that can be altered. In other words, one color emitted through the filter cancels the other color out causing the filter to be blacked-out. By using filters one can achieve multiple appearances in the same part, but the designs must not overlap and there is a limit on the usage of colors.

The object of the present invention is to create a visible light that is illuminated through a trim component that has the option to be changed in the trim piece. Current solutions offer only appearance using a printing pattern, stenciled or mask that must be part of the assembled component in order to create the light of the appearance of the trim part. The present invention seeks to provide multiple appearances within the same component and also provide different lighting options through the individual layer.

### SUMMARY OF THE INVENTION

The present invention is directed to a stacked transparent lighting arrangement for a vehicle interior trim component. The vehicle interior trim component can be any trim component or visible surface in the interior of a vehicle. Examples include but are not limited to an instrument panel, arm rest, glove compartment door, door trim piece, headliner, foot pedal or seat cover. The lighting arrangement includes a housing forming part of the vehicle interior trim component. One or more layers of transparent optics contained in the housing with an appearance formed each of the one or more layers of transparent optics. The appearance can be any type of numbers, letters, graphics or other indicia, including but not limited to words, logos or designs.

The stacked transparent lighting arrangement further includes a light source connected to each one of the one or more layers of transparent optics. An appearance is visible on the one or more layers of transparent optics when the light source is activated to illuminate the one of the one or more layers of transparent optics. Connected to the housing is an opaque outer layer forming an outer layer of the stacked transparent lighting arrangement and the vehicle interior trim component, such that the opaque outer layer is opaque when the light source is inactive and the appearance is visible through the opaque outer layer when the light source is activated.

### BRIEF DESCRIPTION OF THE DRAWINGS

The present invention will become more fully understood from the detailed description and the accompanying drawings, wherein:

FIG. 1 is an exploded schematic view of a trim component arrangement in accordance with the present invention;

FIG. 2 is a perspective environmental view of the present invention used in a vehicle interior; and

FIG. 3A is a front plan view of the stacked transparent lighting arrangement in accordance with one embodiment of the invention;

FIG. 3B is a front plan view of the stacked transparent lighting arrangement in accordance with one embodiment of the invention; and

FIG. 3A is a front plan view of the stacked transparent lighting arrangement in accordance with one embodiment of the invention.

### DETAILED DESCRIPTION OF THE PREFERRED EMBODIMENTS

The following description of the preferred embodiment(s) is merely exemplary in nature and is in no way intended to limit the invention, its application, or uses.

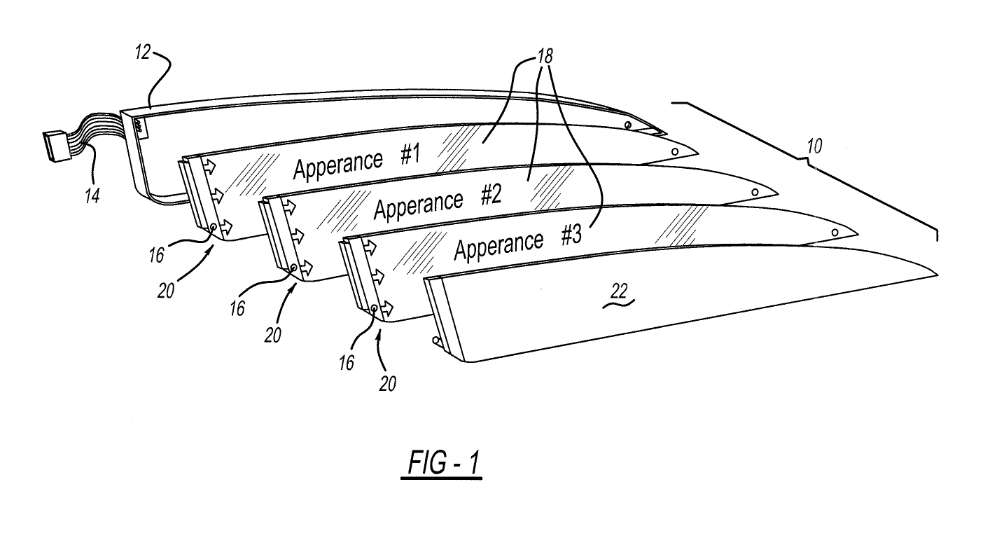

Referring now to FIG. 1, the stacked transparent lighting arrangement 10 for a vehicle trim component is shown. The stacked transparent lighting arrangement 10 includes a housing 12 having an electrical connector 14 connected to the housing for providing power to one or more light sources 16. Within the housing 12 are one or more layers of transparent optics 18 each having a respective light source 16 connected to a side edge 20 of the individual one or more layers of transparent optics 18. Each one of the one or more layers of transparent optics has an appearance within the individual one or more layers of transparent optics that is visible when the respective light source 16 is activated and illuminates the selected one or more layers of transparent optics.

The transparent optics 18 are such that each has an individual appearance that can be viewed either individually or in combination with the other appearance of the other layers of transparent optics 18. The transparent optic 18 layers make it possible for overlapping appearances to not blackout or disrupt the adjacent transparent optic 18 layer because the appearance is not visible unless the layer is illuminated by the respective light source. The appearance can be any type of letters, graphics or other indicia, including but not limited to words, logos and designs.

The stacked transparent lighting arrangement 10 further includes an opaque outer layer 22 forming an outer layer of the stack transparent lighting arrangement 10. The opaque outer layer is opaque or blacked out when the light source(s) 16 are inactive and the appearance of each individual one or more layers of transparent optics 18 can be viewed through the opaque outer layer when illuminated with activation of the respective light source 16.

FIG. 1 shows Appearance #1, Appearance #2 and Appearance #3 in an individual transparent optic 18 with all the transparent optics being stacked adjacent with their individual Appearance #1, Appearance #2 and Appearance #3 overlapping each other. Each Appearance #1, Appearance #2 and Appearance #3 of each individual transparent optic 18 is viewable through the opaque outer layer 22 when illuminated individually.

In another aspect of the invention the appearance on each individual transparent optic 18 can be arranged so that it does no overlap the appearance on the other individual transparent optic 18 in the stacked transparent lighting arrangement. This allows for each transparent optic to be illuminated simultaneously or in a desired series to create an overall combination visual effect.

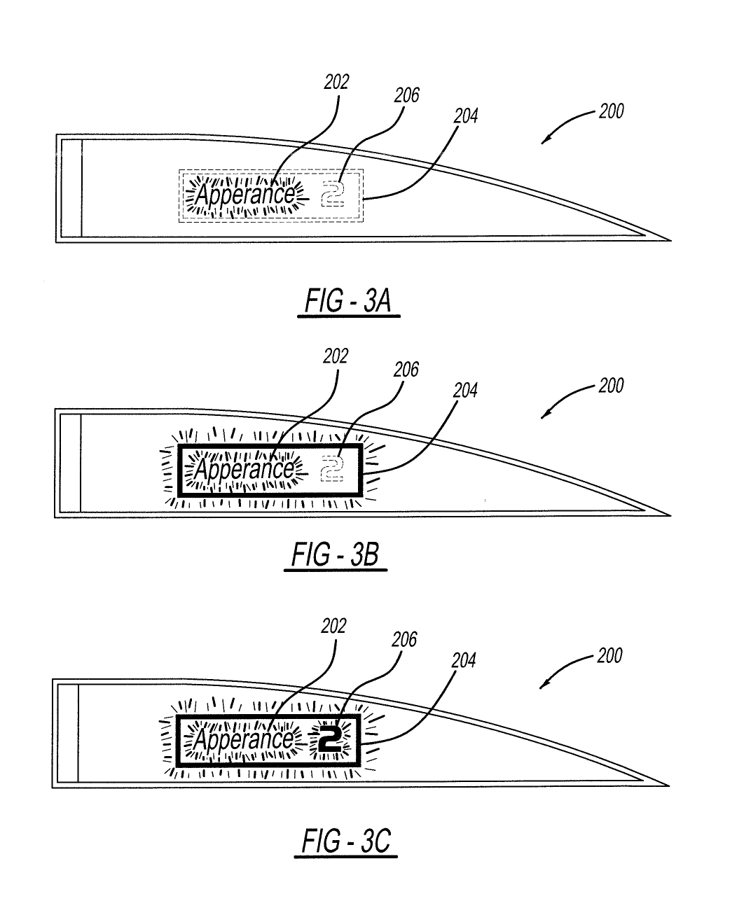

FIGS. 3A, 3B and 3C illustrate the overall visual combination effect that can be achieved. As described above the Appearance #1, Appearance #2 and Appearance #3 on each of the transparent optics 18 can be numbers, letters, graphics, or combinations thereof. In FIGS. 3A, 3B and 3C a stacked transparent lighting arrangement 200 is shown where a first appearance 202 is illuminated with letters spelling the word “Appearance”. A second appearance 206 is a graphic, which is in the shape of a rectangle and a third appearance 208 is a number “2”. The first appearance 202, second appearance 204 and third appearance 206 are all located on individual transparent optics, like the transparent optics 18 as shown in FIG. 1 having Appearance #1, Appearance #2 and Appearance #3 written thereon. The difference between Appearance #1, Appearance #2 and Appearance #3 and the appearances 202, 204 and 206 of FIGS. 3A, 3B and 3C is that appearances 202, 204 and 206 do not overlap, which allows each transparent optic 18 be illuminated simultaneously or in series to create a unique visual combination effect.

One example of the unique visual combination effect involves illuminating appearance 202 but not, appearance 204 and appearance 206 as shown in FIG. 3A. Then in FIG. 3B appearance 202 and appearance 204 are illuminated but not appearance 206. Lastly in FIG. 3C all three appearances 202,204 and 206 are illuminated and create a unique visual appearance that is different from FIGS. 3b and 3A. It is within the scope of this invention to illuminate each non-overlapping appearance in any desired order to create different effects. Another example of this combination visual effect would be to have a vehicle manufacturer's name written with words on one of the transparent optics. A second transparent optic could have the manufacturer's logo outline that does not overlap the name written on the first transparent optic. The stacked transparent lighting arrangement could be programmed to light the two transparent optics in various sequences to create an appealing lighting effect.

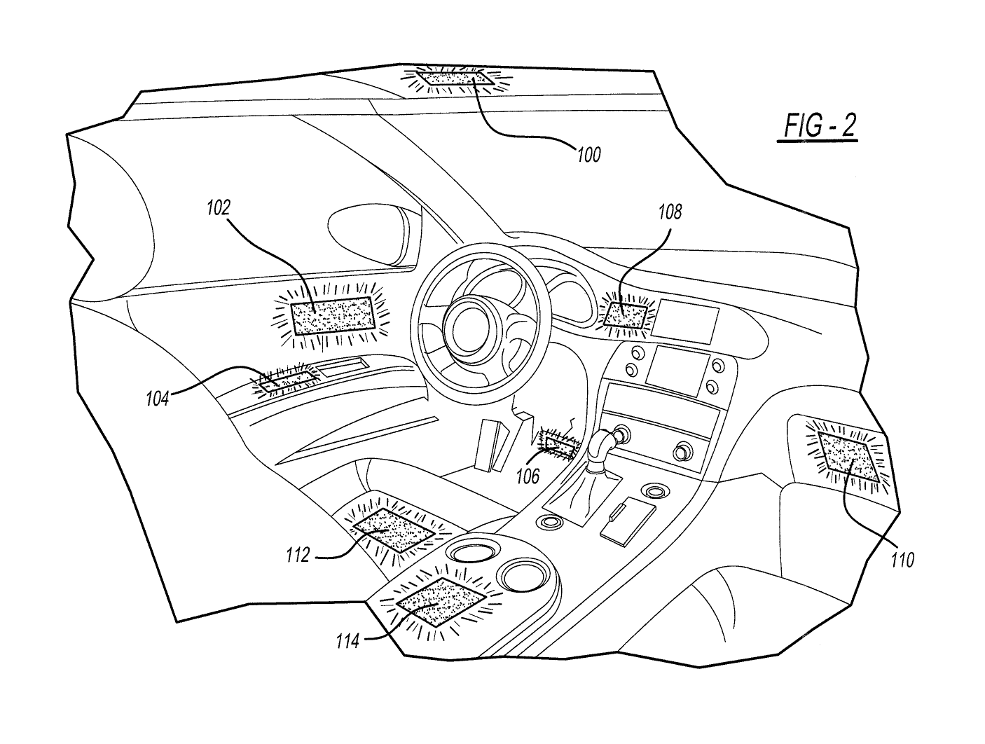

Referring now to FIG. 2 an environmental view of the stacked transparent lighting arrangement incorporated into various surfaces of a vehicle interior are shown. A stacked transparent arrangement 100 is shown being incorporated into the surface of a headliner is shown. At a second location a stacked transparent arrangement 102 is shown being incorporated into a vehicle door trim piece. A stacked transparent arrangement 104 and 114 are shown incorporated on arm rest surfaces. The vehicle seating surfaces of the vehicle interior also may have a stacked transparent arrangement 112 on the seating surface of the vehicle. It is also within the scope of this invention for a stacked transparent arrangement 108 and 110 to be incorporated on the respective vehicle instrument panel and glove compartment door. FIG. 2 also shows a stacked transparent arrangement 106 located on a vehicle foot pedal. While various location surfaces on the interior are shown, it is within the scope of the invention to have a stacked transparent arrangement located on virtually any interior surface of the vehicle.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1-9. (canceled)

10. A stacked transparent lighting arrangement for a vehicle interior trim component comprising:
a housing forming part of a vehicle interior trim component;
a plurality of layers of transparent optics contained in the housings, wherein each one of the plurality of layers of transparent has an individual appearance formed in the respective plurality of layers of transparent optics;
an individual light source connected to each one of the plurality of layers of transparent optics, wherein the individual appearance is visible on each the plurality layers of transparent optics when the select individual lights source of each on of the plurality of layers of transparent optics is activated to illuminate the one of the plurality of layers of transparent optics;
an opaque outer layer forming an outer layer of the stacked transparent lighting arrangement and the vehicle interior trim component, such that the opaque outer layer is opaque when the individual light source is inactive and the individual appearance is visible through the opaque outer layer when the individual light source is activated.

11. The stacked transparent lighting arrangement for a vehicle interior trim component of claim 10 wherein each individual appearance of the each one of the plurality of layers of transparent optics is viewable either individually or in combination with all other the individual appearance of all other the plurality of layers of transparent optics.

12. The stacked transparent lighting arrangement for a vehicle interior trim component of claim 11 wherein any the individual appearance that is not illuminated by the individual light source will not not blackout or disrupt any individual appearance that is illuminated

13. The stacked transparent lighting arrangement for a vehicle interior trim component of claim 8 wherein a respective the individual light source is connected to a side edge of each one of the plurality of layers of transparent optics.

14. The stacked transparent lighting arrangement for a vehicle interior trim component of claim 10 further comprising an electrical connector connected to the housing for providing power to each individual light source.

15. The stacked transparent lighting arrangement for a vehicle interior trim component of claim 10 further comprising the vehicle interior trim component being an instrument panel, arm rest, glove compartment door, door trim piece, headliner, foot pedal or seat cover.

16. The stacked transparent lighting arrangement for a vehicle interior trim component of claim 10 wherein each appearance includes one selected from the group consisting of numbers, letters, graphics, or combinations thereof.

17. A stacked transparent lighting arrangement for a vehicle interior trim component comprising:
a vehicle interior trim component being one or more selected from the group consisting of an instrument panel, arm rest, glove compartment door, door trim piece, headliner, foot pedal, and seat cover;
a housing forming part of the vehicle interior trim component;
a plurality of layers of transparent optics contained in the housings, wherein each one of the plurality of layers of transparent has an individual appearance formed in the respective plurality of layers of transparent optics;
an individual light source connected to each one of the plurality of layers of transparent optics, wherein the individual appearance is visible on each the plurality layers of transparent optics when the select individual lights source of each on of the plurality of layers of transparent optics is activated to illuminate the one of the plurality of layers of transparent optics; and
an opaque outer layer forming an outer layer of the stacked transparent lighting arrangement and the vehicle interior trim component, such that the opaque outer layer is opaque when the individual light source is inactive and the individual appearance is visible through the opaque outer layer when the individual light source is activated.

18. The stacked transparent lighting arrangement for a vehicle interior trim component of claim 17 wherein a respective the light source is connected to a side edge of each one of the one or the one or more layers of transparent optics.

19. The stacked transparent lighting arrangement for a vehicle interior trim component of claim 17 further comprising an electrical connector connected to the housing for providing power to the light source.

20. The stacked transparent lighting arrangement for a vehicle interior trim component of claim 17 wherein each appearance includes one selected from the group consisting of numbers, letters, graphics, or combinations thereof.
